(19) United States
(12) Patent Application Publication
(10) Pub. No.: US 2008/0190314 A1
(43) Pub. Date: Aug. 14, 2008

(54) Method for Printing the Surface of a Chair Base by Water Transfer Printing and the Chair Base Structure

(76) Inventor: Tsung-Chun Chou, Shengang Township (TW)

Correspondence Address: Dr. BANGER SHIA, 102 Lindencrest Ct., Sugar Land, TX, 77479-5201, US

(21) Appl. No.: 11/673,576

(22) Filed: Feb. 10, 2007

(51) Int. Cl. B41F 1/16

(52) U.S. Cl. 101/492

(57) ABSTRACT

A method for printing the surface of a chair base by water transfer printing comprises the steps of: a. pretreating the object to be printed; b. applying base coat or interface coat; c. drying and baking; d. putting transfer paper in a water transfer tank; e. applying activator; f. transfer printing; g. washing with water; h. drying: and i. applying finishing coat. The chair base printed with patterns by water transfer printing is improved both in aesthetic appearance and wear resistance. Further, during the printing process, the printed patterns can be protected by the surface film.

### BACKGROUND OF THE INVENTION

1. Field of the Invention

The present invention relates to a technology of printing the surface of a chair base by water transfer printing, and more particularly to a method for printing the surface of a chair base by water transfer printing and the chair base structure.

2. Description of the Prior Art

Due to the aesthetic requirement, the base of some conventional chairs is made of wood in order to get a surface with real wood grains. However, the use of wood has the problems of cost intensive, low hardness, susceptible to wear and tear, environmental conservation, and etc. The existing chair base is either made of plastic or metal, and the surface of the chair base is usually subjected to simple surface treatment, for example, the chair base is made of plastic added with pigment to have a colorful surface, or the surface of metal chair base is treated with electroplating or sprayed with protection paint to improve the aesthetic perception while obtaining an anti-rust effect. Anyway, the various surface treatments are all made to protect the material of the chair base but not to ensure an aesthetic appearance. Therefore, the color of the conventional chair base is monotonous and lacks diversity, and patterns or grains are seldom seen in the surface of the chair base. The chair has a long history of thousands of years, and is an indispensable article of use in daily life. Except for the improvement made to the shape, the function and the aesthetic effect of the chair and the seat, no one before had thought of improving the aesthetic effect of the chair by printing the surface of the chair base. In addition, the surface of the chair base is usually curving and irregularly shaped, it is impossible to print an intact pattern on the surface of the chair base. Further, the chair is usually moved here and there, the electroplating layer on the surface of the chair base is likely to peel, and the surface of the chair base is liable to wear, as time passes, metal chair base will be rusted, affecting the aesthetic appearance, and the peeled off rusted blocks will contaminate the environment.

The present invention has arisen to mitigate and/or obviate the afore-described disadvantages.

### SUMMARY OF THE INVENTION

The primary objective of the present invention is to provide a method for printing the surface of a chair base by water transfer printing, so as to enable the chair base to be printed with various colorful patterns, thus overcoming the problem of the conventional chair base of monotonous color and having no patterns, while improving the aesthetic effect of the whole chair. Further, the surface of the chair base is covered with finishing coat to protect the printed pattern. Therefore, the chair base printed with pattern by this method is also improved in terms of wear resistance. In addition, the present invention is suitable for curving surface printing and can prevent the phantom problem of the conventional printing method. During the printing process, the surface of the chair base is printed by filming contacting method, thus preventing the surface of the chair base from being damaged while ensuring its intactness.

The secondary objective of the present invention is to provide a method for printing the surface of a chair base by water transfer printing, which is suitable for curving surface printing and can prevent the phantom problem of the conventional printing method. During the printing process, the surface of the chair base contacts the transfer paper via a surface film, thus preventing the surface of the chair base from being damaged while ensuring its intactness.

To obtain the abovementioned objectives, a method for printing the surface of a chair base by water transfer printing in accordance with the present invention comprises the steps of:

a. pretreating the object to be printed: pretreating the chair base to obtain a smooth surface;

b. applying base coat or interface coat: applying base coat or interface coat;

c. drying and baking: drying and-baking the chair base after the base coat or the interface coat is applied;

d. putting transfer paper in a water transfer tank: putting the transfer paper in a water transfer tank;

e. applying activator: applying activator to the surface of the transfer paper;

f. transfer printing: pressing the transfer paper into the water with the dried chair base, the printing ink will be transferred to the surface of the chair base;

g. washing with water: washing the chair base with water;

h. drying: drying the chair base that printed with pattern; and

i. applying finishing coat: applying finishing coat to the surface of the dried chair base printed with pattern.

A chair base printed with pattern by water transfer printing in accordance with the present invention is characterized in that: a surface of the chair base is printed with at least one pattern by water transfer printing technology.

### BRIEF DESCRIPTION OF THE DRAWINGS

FIG. 1 is a flow chart in accordance with the present invention of showing a method for printing the surface of a chair base by water transfer printing; and

FIG. 2 is a perspective view of a chair base printed with pattern by water transfer printing in accordance with the present invention.

### DETAILED DESCRIPTION OF THE PREFERRED EMBODIMENT

The present invention will be more clear from the following description when viewed together with the accompanying drawings, which show, for purpose of illustrations only, the preferred embodiment in accordance with the present invention.

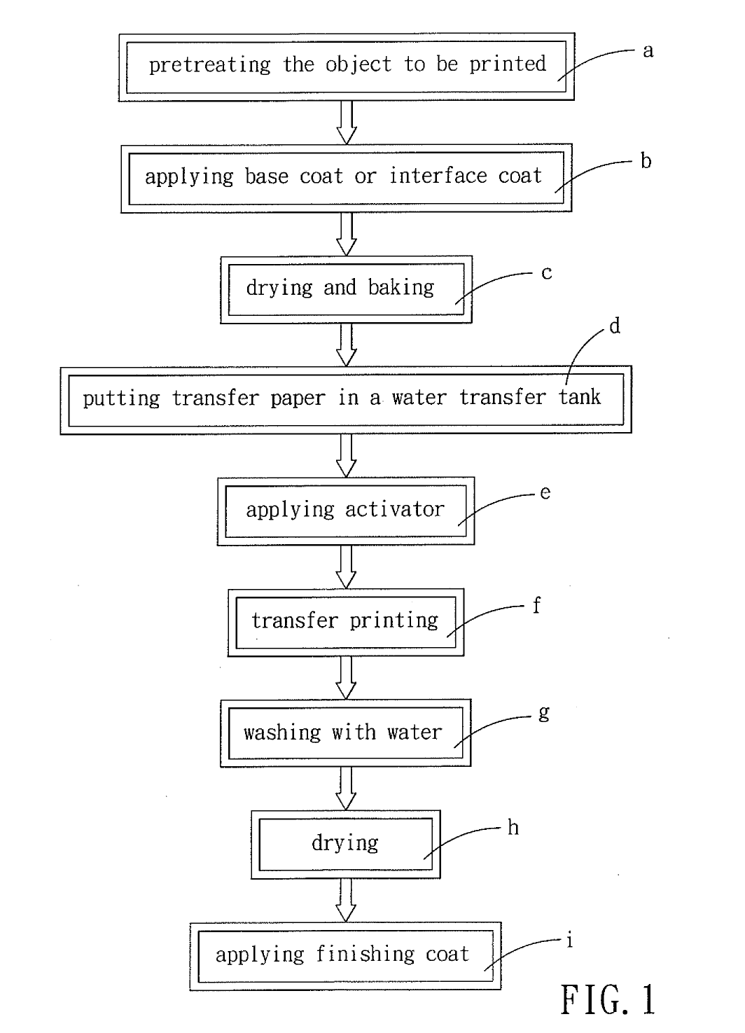

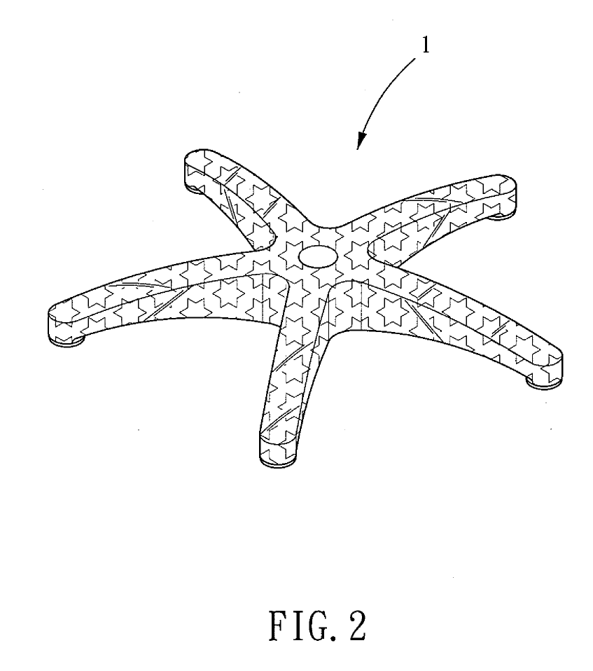

A method for printing the surface of a chair base by water transfer printing in accordance with a preferred embodiment of the present invention is illustrated in FIGS. 1 and 2 and comprises the following steps of:

a. pretreating the object to be printed: the object to be printed in this embodiment is a chair base 1 for example, pretreating the chair base 1 with surface polishing and dust removing treatment to smooth the surface of the chair base, the dust removing treatment includes the methods of water wash, vacuum cleaning, and etc;

b. applying base coat or interface coat: applying base coat or interface coat according to the material of the chair base 1, applying base coat if the color of the material of the chair base 1 is very different from the color of the pattern to be printed, and the color of the base coat should be close to that of the pattern to be printed, so as to cover the color of the material of the chair base; it can apply the interface coat if the material of the chair base 1 is the non-absorbent material (such as metal material) or the non-polar material (such as Polypropylene), the interface coat should be the paint capable of providing strong adhesive force for transfer paper printed with patterns;

c. drying and baking: drying and baking the chair base after the base coat or the interface coat is applied to the chair base 1, and the drying and baking temperature is controlled between 90-110° C.;

d. putting the transfer paper in a water transfer tank: putting the transfer paper in the water transfer tank after the paint drying and baking process, the transfer paper should be placed flat, and the water temperature of the water transfer tank is controlled between 40-50° C.;

e. applying activator: applying activator to the surface of the transfer paper to convert the printing ink into a condition suitable for printing;

L transfer printing: pressing the transfer paper into the water with the dried chair base 1, the printing ink will be transferred to the surface of the chair base 1 when the transfer paper is subjected to the water pressure, so that the surface of the chair base is printed with the patterns previously printed on the transfer paper, it is to be noted that the transfer printing process can be operated manually or automatically;

g. washing with water: washing the chair base I with water to remove the residual transfer paper;

h. drying: drying the chair base 1 printed with at least one pattern; and

i. applying finishing coat: applying finishing coat to the surface of the dried chair base 1 printed with pattern for protecting the pattern from being damaged and for improving the wear resistance of the chair base 1.

While we have shown and described embodiment in accordance with the present invention, it is clear to those skilled in the art that further embodiments may be made without departing from the scope of the present invention.

What is claimed is:

1. A method for printing the surface of a chair base by water transfer printing comprising the steps of:
a. pretreating the object to be printed: pretreating the chair base to obtain a smooth surface;
b. applying base coat or interface coat: applying base coat or interface coat;
c. drying and baking: drying and baking the chair base after the base coat or the interface coat is applied;
d. putting transfer paper in a water transfer tank: putting the transfer paper in a water transfer tank;
e. applying activator: applying activator to the surface of the transfer paper;
f. transfer printing: pressing the transfer paper into water with the dried chair base, printing ink will be transferred from the transfer paper to the surface of the chair base;
g. washing with water: washing the chair base with water;
h. drying: drying the chair base that printed with pattern; and
i. applying finishing coat: applying finishing coat to the surface of the dried chair base printed with pattern.

2. The method for printing the surface of a chair base by water transfer printing as claimed in claim 1, wherein drying and baking temperature in step c is between 90-110° C.

3. The method for printing the surface of a chair base by water transfer printing as claimed in claim 1, wherein water temperature of the water transfer tank in step d is controlled between 40-50° C.

4. A chair base printed with pattern by water transfer printing is characterized in that: a surface of the chair base is printed with at least one pattern by water transfer printing technology.
